(19) United States
(12) Patent Application Publication
(10) Pub. No.: US 2003/0203695 A1
(43) Pub. Date: Oct. 30, 2003

(54) Splittable multicomponent fiber and fabrics therefrom

(76) Inventors: Braulio Arturo Polanco, Canton, GA (US); Paul Richard Holcomb, Asheville, NC (US); James Richard Neely, Greenville, SC (US)

Correspondence Address: KIMBERLY-CLARK WORLDWIDE, INC., 401 NORTH LAKE STREET, NEENAH, WI, 54956

(21) Appl. No.: 10/135,650

(22) Filed: Apr. 30, 2002

(51) Int. Cl. B32B 5/16; D01F 8/00; D04H 1/00; B32B 31/00; D04H 3/00; D04H 5/00; B29C 63/00; D04H 13/00; D02G 3/00

(52) U.S. Cl. 442/365; 428/364; 428/365; 428/373; 442/361; 264/171.1

(57) ABSTRACT

The present invention provides a splittable multicomponent fiber containing at least two polymer components arranged in distinct non-occlusive segments across the cross-section of the fiber, wherein the segments are continuous along the length of the fiber, and wherein at least one of the polymer components comprises about 10 percent to about 95 percent by weight of filler material. The invention also provides split fibers, and fabrics containing the split fibers produced from the splittable multicomponent fiber, and laminates containing the split fiber fabric. Additionally provided is a process for producing the split fibers and fabrics.

### TECHNICAL FIELD

The present invention is related to splittable multicomponent fibers and split fibers obtainable therefrom and to fabrics made from such splittable and split fibers.

### BACKGROUND OF THE INVENTION

Many of the medical care garments and products, protective wear garments, mortuary and veterinary products, and personal care products in use today are partially or wholly constructed of nonwoven materials. Examples of such products include, but are not limited to, medical and health care products such as surgical drapes, gowns and bandages, protective workwear garments such as coveralls and lab coats, and infant, child and adult personal care absorbent products such as diapers, training pants, disposable swimwear, incontinence garments and pads, sanitary napkins, wipes and the like. For these applications nonwoven fibrous webs provide tactile, comfort and aesthetic properties which can approach or even exceed those of traditional woven or knitted cloth materials. Nonwoven materials are also widely utilized as filtration media for both liquid and gas or air filtration applications since they can be formed into a filter mesh of fine fibers having a low average pore size suitable for trapping particulate matter while still having a low pressure drop across the mesh.

Melt extrusion processes for spinning continuous filament yarns and spunbond filaments are well known in the art. These filaments provide advantageous properties, e.g., strength, over microfibers such as meltblown fibers since the molecular chains of the polymers forming the yarn and spunbond filaments have a higher level of orientation than the meltblown microfibers. However, yarn filaments and spunbond filaments typically have a thickness or denier, i.e., a weight-per-unit-length, of greater than 2 denier, and it has been difficult to produce filaments of less than about 2 denier. Yet finer fibers are desirable for nonwoven materials used in skin-contact or filtration applications because fine fiber webs generally have better cloth-like tactile aesthetics and particle trapping properties than coarser fiber webs. One approach in overcoming this difficulty producing fine fibers is fibrillating or splitting continuous filaments or staple fibers into smaller fibrils.

Various methods are known in the art for splitting filaments and fibers. For example, a known method for producing split fiber structures includes the steps of forming multicomponent fibers into a fibrous structure and then treating the fibrous structure with an aqueous emulsion of benzyl alcohol or phenyl ethyl alcohol to split the composite fibers. Another known method has the steps of forming multicomponent filaments into a fibrous structure and then splitting the multicomponent fibers of the fibrous structure by flexing or mechanically working the fibers in the dry state or in the presence of a hot aqueous solution. Yet another method for producing split fibers is a needling process. In this process, multicomponent fibers are hydraulically or mechanically needled to fracture and separate the cross-sections of multicomponent fibers, forming fine denier split fibers. Other methods include those disclosed in U.S. Pat. No. 5,759,926 to Pike et al. and U.S. Pat. No. 5,895,710 to Sasse et al., each incorporated herein by reference in its entirety, wherein multicomponent fibers having at least two incompatible components arranged into distinct segments on the multicomponent fiber, at least one of the incompatible components being hydrophilic or hydrophilically modified, are contacted with hot aqueous fibrillation-inducing medium during or after fiber drawing.

Another method for producing fine fibers, although it is not a split fiber production process, utilizes multicomponent fibers containing one or more polymer components which are soluble in a solvent. For example, a fibrous structure is produced from sheath-core or island-in-sea multicomponent fibers and then the fibrous structure is treated with water or other solvent to dissolve the sheath or sea component, producing a fibrous structure of fine denier fibers of the non-soluble core or island component.

Although many different prior art processes for producing split or dissolved fine denier fibers are known, including the above described processes, each of the prior art processes suffers from one or more drawbacks such as the use of potentially hazardous and expensive chemicals, which may create disposal problems, a long splitting or fibrillation processing time, or a cumbersome and energy intensive mechanical fiber splitting process. These processes also often result in incomplete and non-uniform splitting of the fiber components, particularly where an attempt is made to reduce the splitting time or use mechanical splitting steps which are less energy intensive than customary.

Consequently, there remains a need for a production process that is simple and is not deleterious to the environment and that provides high levels of fiber splitting. Additionally, there remains a need for a fine fiber production process that is continuous and can be used in large commercial scale productions.

### SUMMARY OF THE INVENTION

The present invention provides a splittable multicomponent fiber containing at least two polymer components which are arranged in distinct segments across the cross-section of the fiber along the length of the fiber, wherein the polymer components form distinct non-occlusive cross-sectional segments along the length of the fiber such that the segments are dissociable or splittable. One of the polymer components contains at least about 10 percent by weight of filler material. The polymer components may or may not be incompatible with regard to one another. In one embodiment, the polymer components may be of the same polymer with the exception that one component contains at least about 10 percent by weight of filler material. The multicomponent fiber is highly suitable as a precursor for producing split fibers. The multicomponent fiber is useful as a continuous filament as in meltspun nonwovens, and may also be used to form continuous filament yarns for use in weaving or knitting fabrics, and may be cut into short length fibers for use as staple fibers.

The invention additionally provides split fibers from the splittable multicomponent fiber and a fabric containing the split fibers, such as a nonwoven web or fabric. The nonwoven fabric may be of substantially continuous filaments such as in a spunbond fabric or may be of staple length fibers as in carded webs, air laid webs, and wet laid webs. In addition, the fabric can be a woven or knitted fabric. The invention also provides a laminate of the split fiber fabric and a microfiber web, e.g., a meltblown web, or a film.

The invention also provides a process for producing split fine denier fibers. The process has the steps of providing multicomponent fibers having at least two polymer components which form distinct non-occlusive cross-sectional segments along substantially the entire length of the fibers, wherein one of the polymer components contains at least about 10 percent by weight of filler material, and then splitting the fibers by application of mechanical force or energy such as by hydraulic or mechanical needling, flexing, twisting, brushing, stretching or secondary drawing, scraping, crush-rolling, and by other means as are known in the art.

The fine fibers of the present invention exhibit the strength properties of highly oriented fibers and the fine fiber fabric exhibits the desirable textural, visual and functional properties of microfiber fabric. In addition, many filler materials useful in the fibers of the invention may less expensive than the polymers which they replace, thereby allowing for lowered overall cost of the materials used.

### BRIEF DESCRIPTION OF THE DRAWINGS

FIGS. 1-4B illustrate suitable multicomponent fiber configurations for the present invention.

FIGS. 5-7 illustrate asymmetrical multicomponent fiber configurations that are suitable for producing crimped multicomponent fibers.

FIGS. 8A and 8B illustrate additional suitable multicomponent fiber configurations for the present invention.

FIGS. 9-10 are schematic illustrations of exemplary processes for producing the splittable multicomponent fibers, split fibers, and splittable fiber and split fiber fabrics of the present invention.

### DEFINITIONS

As used herein and in the claims, the term “comprising” is inclusive or open-ended and does not exclude additional unrecited elements, compositional components, or method steps.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries.

As used herein the term “incompatible” polymers refers to polymers having differences in their respective solubility parameters of greater than about 0.5 (cal/cm³)^{1/2}. Generally, incompatible polymers do not form a miscible blend when melt-blended.

As used herein the term “fibers” refers to both staple length fibers and substantially continuous filaments, unless otherwise indicated. As used herein the term “substantially continuous” filament means a filament or fiber having a length much greater than its diameter, for example having a length to diameter ratio in excess of about 15,000 to 1, and desirably in excess of 50,000 to 1.

As used herein the term “monocomponent” fiber refers to a fiber formed from one or more extruders using only one polymer. This is not meant to exclude fibers formed from one polymer to which small amounts of additives have been added for color, antistatic properties, lubrication, hydrophilicity, etc. These additives, e.g. titanium dioxide for color, are conventionally present, if at all, in an amount less than 5 weight percent and more typically about 1-2 weight percent.

As used herein the term “filler” or “filler material” refers to particulate inorganic materials capable of being ground to an average particle fineness, generally speaking a fineness of about 0.5 microns to about 5 microns, and which are able to be mixed with thermoplastic polymers and extruded together with the polymer as a thermoplastic melt. As will be appreciated by those skilled in the art, selection of a particular filler will be influenced by a number of factors such as the end application and the other components, for example, the filler should not adversely react with or otherwise chemically interfere with the thermoplastic polymer. Filler materials are known and used in industry in the production of microporous breathable thermoplastic films for use in personal care absorbent articles, protective garments and the like. Selected filler examples include titanium dioxide, talc and calcium carbonate, which are inexpensive and readily available commercially. Other fillers known in the industry include barium carbonate, magnesium carbonate, magnesium sulfate, mica, clays, kaolin, diatomaceous earth and the like. In addition, organic particulate materials for use as fillers such as wood and other cellulose powders, polymer particles, and chitin and chitin derivatives are known and can be used in accordance with the invention. The filler particles may optionally be coated with a fatty acid, such as stearic acid, which may facilitate the free flow of the particles (in bulk) and their ease of dispersion into the polymer matrix.

As used herein the term “filled” refers to a polymer component which contains at least about 10 percent by weight of filler material.

As used herein the term “multicomponent fibers” refers to fibers which have been formed from at least two component polymers, or the same polymer with different properties or additives, extruded from separate extruders but spun together to form one fiber. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration of such a multicomponent fiber may be, for example, a sheath/core arrangement wherein one polymer is surrounded by another, or may be a side by side arrangement, an “islands-in-the-sea” arrangement, or arranged as pie-wedge shapes or as stripes on a round, oval or rectangular cross-section fiber. Multicomponent fibers are taught in U.S. Pat. No. 5,108,820 to Kaneko et al., U.S. Pat. No. 5,336,552 to Strack et al., and U.S. Pat. No. 5,382,400 to Pike et al. For two component fibers, the polymers may be present in ratios of 75/25, 50/50, 25/75 or any other desired ratios.

As used herein the term “splittable” when referring to a fiber or filament means a multicomponent fiber containing at least two polymer components which are arranged in distinct segments across the cross-section of the fiber along the length of the fiber, wherein the polymer components form distinct non-occlusive cross-sectional segments along the length of the fiber such that the segments are dissociable upon application of force or energy. Desirably at least about 20 percent of the fibers should split into at least two distinct segments using conventional splitting treatments or techniques as are known in the art such as hydraulic or mechanical needling, flexing, twisting, brushing, stretching or secondary drawing, scraping or crush-rolling. By way of example, where the fibers have been formed into a web and subjected to a splitting treatment, upon microscopic examination of a 2 inch (5.08 cm) by 2 inch (5.08 cm) square of the web at least 20 percent of the observable fibers should show splitting along at least a portion of its observable length. It should be noted that a given fiber may not necessarily split into its component segments along its entire length but rather may exhibit regions along its length of splitting and non-splitting, alternatingly or otherwise, depending upon the type of splitting means selected and uniformity of application of force or energy upon the length of the fiber.

As used herein the term “nonwoven web” or “nonwoven fabric” means a web having a structure of individual fibers or filaments which are interlaid, but not in an identifiable manner as in a knitted or woven fabric. Nonwoven fabrics or webs have been formed from many processes such as for example, meltblowing processes, spunbonding processes, and carded web processes. The basis weight of nonwoven fabrics is usually expressed in grams per square meter (gsm) or ounces of material per square yard (osy) and the fiber diameters useful are usually expressed in microns. (Note that to convert from osy to gsm, multiply osy by 33.91).

The term “spunbond” or “spunbond fiber nonwoven fabric” refers to a nonwoven fiber fabric of small diameter filaments that are formed by extruding molten thermoplastic polymer as filaments from a plurality of capillaries of a spinneret. The extruded filaments are cooled while being drawn by an eductive or other well known drawing mechanism. The drawn filaments are deposited or laid onto a forming surface in a generally random, isotropic manner to form a loosely entangled fiber web, and then the laid fiber web is subjected to a bonding process to impart physical integrity and dimensional stability. The production of spunbond fabrics is disclosed, for example, in U.S. Pat. No. 4,340,563 to Appel et al., U.S. Pat. No. 3,802,817 to Matsuki et al. and U.S. Pat. No. 3,692,618 to Dorschner et al. Typically, spunbond fibers have a weight-per-unit-length in excess of 2 denier and up to about 6 denier or higher, although finer spunbond fibers can be produced.

As used herein the term “meltblown fibers” means fibers formed by extruding a molten thermoplastic material through a plurality of fine, usually circular, die capillaries as molten threads or filaments into converging high velocity gas (e.g. air) streams which attenuate the filaments of molten thermoplastic material to reduce their diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers may be continuous or discontinuous, are generally smaller than 10 microns in diameter, and are generally tacky when deposited onto a collecting surface.

The term “staple fibers” refers to discontinuous fibers, which typically have an average diameter similar to that of spunbond fibers. Staple fibers may be produced with conventional fiber spinning processes and then cut to a staple length, typically from about 1 inch (2.54 cm) to about 8 inches (20.32 cm). Such staple fibers are subsequently carded or airlaid and thermally or adhesively bonded to form a nonwoven fabric.

As used herein “carded webs” refers to nonwoven webs formed by carding processes as are known to those skilled in the art and further described, for example, in coassigned U.S. Pat. No. 4,488,928 to Alikhan and Schmidt which is incorporated herein in its entirety by reference. Briefly, carding processes involve starting with staple fibers in a bulky batt that is combed or otherwise treated to provide a generally uniform basis weight. A carded web may then be bonded by conventional means as are known in the art such as for example through air bonding, ultrasonic bonding and thermal point bonding.

As used herein, “thermal point bonding” involves passing a fabric or web of fibers or other sheet layer material to be bonded between a heated calender roll and an anvil roll. The calender roll is usually, though not always, patterned in some way so that the entire fabric is not bonded across its entire surface. As a result, various patterns for calender rolls have been developed for functional as well as aesthetic reasons. One example of a pattern has points and is the Hansen Pennings or “H&P” pattern with about a 30% bond area with about 200 bonds/square inch (about 31 bonds/square cm) as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen and Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Other common patterns include a diamond pattern with repeating and slightly offset diamonds and a wire weave pattern looking as the name suggests, e.g. like a woven window screen. Typically, the percent bonding area varies from around 10% to around 30% of the area of the fabric laminate web.

As used herein, the term “hydrophilic” means that the polymeric material has a surface free energy such that the polymeric material is wettable by an aqueous medium, i.e. a liquid medium of which water is a major component. The term “hydrophobic” includes those materials that are not hydrophilic as defined. The phrase “naturally hydrophobic” refers to those materials that are hydrophobic in their chemical composition state without additives or treatments affecting the hydrophobicity. It will be recognized that hydrophobic materials may be treated internally or externally with surfactants and the like to render them hydrophilic.

### DETAILED DESCRIPTION OF THE INVENTION

The present invention provides splittable multicomponent fibers and fine fibers produced from splitting the multicomponent fibers and a method for producing the same. The invention additionally provides knit, woven and nonwoven fabrics containing the split fine fibers. The splittable multicomponent fibers can be characterized in that each splittable fiber contains at least two component polymers and at least one of the component polymers contains at least about 10 percent by weight of filler material.

The splittable multicomponent fiber of the present invention may be split by the application of forms of mechanical force or energy such as for example stretching or secondary drawing, brushing, twisting, flexing, scraping, crush rolling, and hydraulic or mechanical needling. The application of mechanical force or energy may be performed on the multicomponent fibers themselves, or upon a fabric comprising the multicomponent fibers. Depending upon the end-use need, at least about 20% of the multicomponent fibers should split. For uses where higher numbers of the fine denier fibers are desired, at least about 50%, desirably at least about 75%, most desirably at least about 95% and up to 100% of the multicomponent fibers split.

The present splittable multicomponent fiber and split-fiber production process is highly advantageous over prior art split fiber production processes. Unlike prior art fiber splitting processes, the splitting process does not require the use of incompatible polymer pairings, nor does it require the use of hazardous or expensive chemicals; rather, the invention only requires use of relatively inexpensive filler materials. In addition, the present splitting process does not produce by-products that need to be disposed of or recovered since the present splittable fibers do not require environmentally harmful chemicals and do not require dissolving component polymers of the fibers to produce split fibers. Furthermore, as mentioned above, since the present invention does not require the use of incompatible polymer pairings, the least expensive polymers may be used for the components of the multicomponent fiber. The cost of raw materials may also be reduced where more expensive polymers are selected due to end-use needs, because the filler material replaces polymer at the level of loading, and generally speaking it may be possible to select filler materials which are less expensive than the polymer of the component in which they are loaded. For example, for a component polymer loaded at the 20 percent level with a less expensive filler material, 20 percent less of the component polymer is used than would be the case for an unfilled component.

The extent of fiber splitting in the present invention may be controlled by various parameters. For example, the amount of filler loading for the filled component of the multicomponent fibers can be adjusted upwards from 10 percent by weight of the component to increase the extent of splitting and amount of fibers which split. For certain applications a minimum filler loading of 15 percent may be desired, and for still other applications a minimum filler loading of 20 percent or even 30 percent may be desired. However, while we do not wish to place any upper limits on filler loading amount, it should be noted that filler loading level may be limited by practical considerations such as desired fiber size and fiber spinning or processing conditions. While it may be possible to load the filled polymer component of the multicomponent fiber to a level of 95 percent by weight filler material, very high levels of loading may result in a fiber which, depending on processing method selected, is difficult to draw during the initial or molten drawing stage making it difficult to produce smaller diameter fibers, or result in a fiber which breaks easily during that initial drawing. For practical considerations and depending on process operating conditions, it may be desirable to load the filled component to no more than 85 percent by weight of filler material. For other process operating conditions, it may be desirable to load the filled component to no more than 70 percent. For still other operating conditions it may be desirable to load the filled component to no more than 50 percent, or even to no more than 30 percent. In addition to filler loading amount, the amount of mechanical force or energy can be increased or decreased to cause more or less fiber splitting, depending on desired end use and amount of splitting desired.

As stated above, the splittable multicomponent fiber should have a cross-sectional configuration which is amenable to partial or complete dissociation. Accordingly, at least one dissociable segment of the cross-section of the multicomponent fiber, which is occupied by one of the component polymers of the fiber, forms a portion of the peripheral surface of the fiber and has a configuration that is not occluded or enveloped by adjacent segments such that the dissociable segment is not physically impeded from being separated from the adjacent segment or segments. For example, two polymer components may be alternatingly disposed to form a unitary multicomponent fiber wherein one of the alternating polymer components is filled, i.e. comprises at least about 10 percent by weight of filler material. As another example, three or more different polymer components may be alternatingly disposed to form multicomponent fiber wherein every other alternating polymer component is filled. As still another example, the same polymer may be used for all of the alternating polymer components of the multicomponent fiber, except that every other adjacent component is filled with at least about 10 percent by weight of filler material.

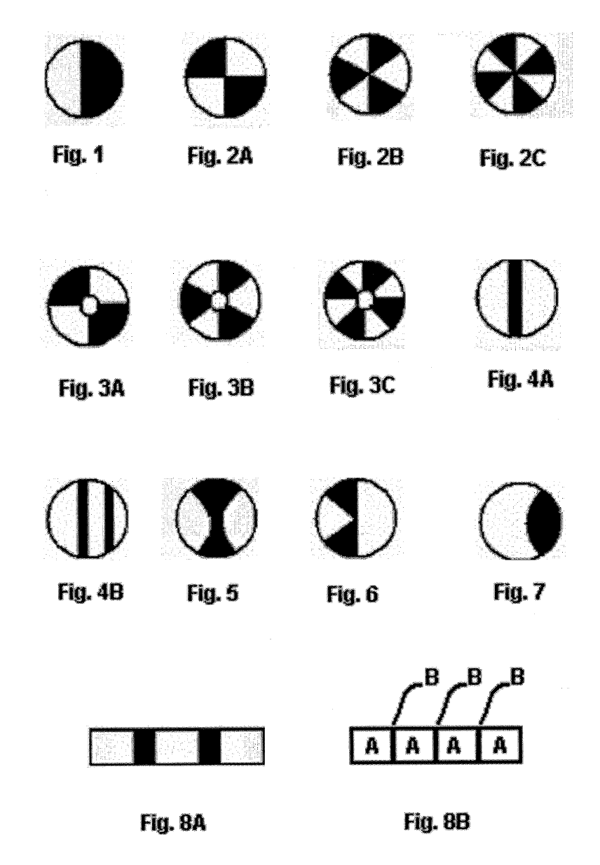

Suitable non-occlusive configurations for the multicomponent fibers include side-by-side configurations such as in FIG. 1, wedge configurations such as in FIGS. 2A-2C, hollow wedge configurations as in FIGS. 3A-3C, and sectional configurations as in FIGS. 4A-4B. It should be noted that although these FIGS. 1 through 4B depict multicomponent fiber configurations wherein individual components occupy approximately equal portions of the cross sectional area of the entire fiber, they need not be limited to such. For example, in the fiber depicted in FIG. 2A each of the two shaded and two non-shaded components occupies approximately 25 percent of the cross sectional area of the entire fiber; however, a multicomponent fiber wherein the two shaded components each occupy 35 percent, and each of the non-shaded components occupy 15 percent, of the cross sectional area of the fiber would also be suitable. Other variations in the distribution of the individual components of the multicomponent fiber are of course possible and will be evident to one of ordinary skill in the art.

FIG. 5 illustrates a 4-piece wedge configuration of a multicomponent fiber that has two larger wedges and two smaller wedges, with the larger wedges having joined together in the center of the fiber cross-section. It is to be noted that a suitable configuration does not need to have a symmetrical geometry so long as it is not occlusive or interlocking of the different components. Correspondingly, suitable configurations also include asymmetrical configurations, for example, as shown in FIGS. 6-7. FIG. 6 illustrates a multicomponent fiber of a wedge configuration that has one unevenly large segment of a component polymer, and FIG. 7 illustrates a multicomponent fiber of an eccentric sectional configuration that has an unevenly large end segment of a component polymer, which results in split fibers of unequal diameters for various applications.

These asymmetrical configurations are suitable for the formation of crimps in the multicomponent fibers and, thus, for increasing the bulk or loft of the fabric produced from the fibers, as is further discussed below. In addition, the different component polymers of the multicomponent fiber need not be present in equal amounts. As an example, a component polymer of the multicomponent fiber may be present in the form a thin strip or film-like section that merely acts as a divider between two adjacent polymer components, thus providing for fine denier fibers and fabrics therefrom comprising mainly one polymer component. Additionally, a component polymer can be asymmetrically placed within the cross-section of the multicomponent fiber such that the split fibers produced therefrom have various cross-sectional shapes.

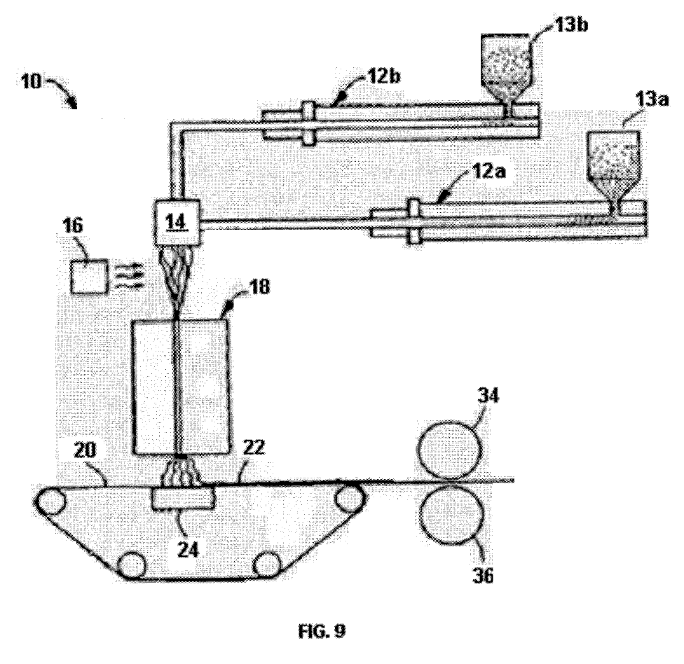

The splittable multicomponent fibers need not be conventional round fibers. Other useful fiber shapes include rectangular, oval and multi-lobal shapes and the like. FIGS. 8A and 8B illustrate cross-sections of exemplary rectangular multicomponent fibers particularly suitable for the present invention. The thin rectangular or ribbon shape of the multicomponent fiber provides a higher surface area that can be exposed to the mechanical force or energy, better facilitating splitting of the multicomponent fiber. As discussed above and as can be seen from FIG. 8B, the alternating component polymers of the multicomponent fiber may be present in the form of thin strips or film-like sections (denoted component “B” in FIG. 8B) which act as dividers between sections of component “A” polymer. In the multicomponent fiber illustrated in FIG. 8B, the resulting group of fibers and/or fabric formed therefrom would comprise mostly component “A”.

The splittable multicomponent fibers may be crimped or uncrimped. Crimped splittable multicomponent fibers of the present invention are highly useful for producing bulky or lofty woven and nonwoven fabrics since the fine fibers split from the multicomponent fibers largely retain the crimps of the multicomponent fibers, and the crimps increase the bulk or loft of the fabric. Such lofty fine fiber fabric of the present invention exhibits cloth-like textural properties, e.g., softness, drapability and hand, as well as desirable strength properties of a fabric containing highly oriented fibers. As for uncrimped split fiber fabrics, such fabrics provide improved uniform fiber coverage and strength properties as well as improved hand and texture.

In accordance with the invention, split fibers having various thicknesses can be conveniently produced by adjusting the thickness of the multicomponent fibers and/or adjusting the number of segments or zones within the cross-section of the multicomponent fibers. In general, a multicomponent fiber having a finer thickness and/or a higher number of cross-sectional segments results in finer split fibers. Correspondingly, the thickness of the split fibers can be controlled to have a wide variety of thicknesses. Of the suitable thickness controlling methods, the method of adjusting the number of cross-sectional segments is particularly desirable for the present invention.

Polymers suitable for the present invention include polyolefins, polyesters, polyamides, polycarbonates and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6112, nylon 12/12, copolymers of caprolactam and alkylene oxide diamine, and the like, as well as blends and copolymers thereof. Suitable polyesters include polyethylene terephthalate, polybutylene terephthalate, polytetramethylene terephthalate, polycyclohexylene-1,4-dimethylene terephthalate, and isophthalate copolymers thereof, as well as blends thereof. Selection of polymers for the components of the multicomponent fibers is guided by end-use need, economics, and processability. The list of suitable polymers herein is not exhaustive and other polymers known to one of ordinary skill in the art may be employed, so long as the polymers selected for the components of the multicomponent fiber are capable of being co-spun in a fiber extrusion process.

Processes suitable for producing the multicomponent fibers of the present invention include conventional textile filament production processes, staple fiber production processes and spunbond fiber production processes. These multicomponent fiber production processes are known in the art. For example, U.S. Pat. No. 5,382,400 to Pike et al., herein incorporated by reference, discloses a suitable process for producing multicomponent fibers and webs thereof.

The multicomponent fibers and filaments of the invention can be formed into a nonwoven fabric or processed into a woven fabric. For example, spunbond filaments can be directly deposited onto a forming surface to form a nonwoven fabric. Alternatively, staple fibers can be carded, wet laid, or air laid to form a nonwoven fabric. Additionally, a spun yarn of the staple fibers or continuous filaments can be processed into a woven or knitted fabric by a conventional textile processes. For nonwoven fabrics, the multicomponent fibers can be formed into a nonwoven web and then split before or after the nonwoven web is bonded to form a structurally stable nonwoven fabric. For knitted and woven fabrics, the multicomponent fibers can be split before or after the fibers have been processed into a fabric.

The present multicomponent fibers have at least one filled component, that is, at least one component polymer of the multicomponent fiber contains at least about 10 percent by weight of filler material. For ease of incorporating the filler material into the at least one component polymer of the multicomponent fiber, the filler material may be compounded with a base of the component polymer. For example, the filler material may be compounded into a filler-component polymer compound at a 50 percent by weight loading level. Then, during the production of the multicomponent fiber, the 50 percent filler-polymer compound additive is added to the virgin component polymer at a rate of 20 kilograms of filler-polymer compound to 80 kilograms of virgin component polymer in order to produce a multicomponent fiber wherein the filled component contains 10 percent by weight of the filler material (i.e., the filled component is filler-loaded at 10 percent). As another example, addition of a 50 percent filler-polymer compound at a rate of 60 kilograms of filler-polymer compound to 40 kilograms of virgin component polymer would achieve a multicomponent fiber wherein the filled component is filler-loaded at 30 percent. Other filler loading levels may be employed; however it should be noted that very high levels of filler loading may deleteriously affect fiber spinning ability, such as for example reduced ability to draw the fiber down in fineness during melt-drawing, or increased incidence of fiber breakage during fiber drawing.

As will be recognized by those skilled in the art, where a filler-component polymer compound additive is utilized to incorporate the filler into the component, other filler levels than the 50 percent filler-component polymer compound described above may be used. In addition, other means for incorporating the filler material as are known in the art may be employed, such as for example by coating the filler material onto pellets of the virgin component polymer. It should also be noted that while generally a single filler material will be selected to produce a fiber of the invention, combinations of filler materials may be used in the filled component of the multicomponent fiber. As an example, the filled component of the multicomponent fiber may comprise 5 percent by weight of one filler material and 5 percent by weight of a second filler material, thereby comprising a total of 10 percent by weight of filler material.

While not wishing to be bound by any particular theory, we believe that the addition of filler material to at least one component of the multicomponent fiber acts to raise the average surface energy of the filled component such that the difference between the surface energy of the filled component and the non-filled component increases dramatically, acting to create an interface between the adjacent components such that the adjacent components are less able to adhere to one another. Applicants believe the filler material selected should desirably have a surface energy of greater than 100 dynes/cm, more desirably greater than 200 dynes/cm, still more desirably greater than 300 dynes/cm, and most desirably greater than 400 dynes/cm. For example, the surface energies of polyolefins such as polypropylene and polyethylene are relatively close, both being about 30 dynes/cm. Even for polymer pairings which may be described as incompatible or immiscible, the surface energies are still relatively close. For example, the surface energies for polyesters and nylons are generally in the range of about 30 to about 45 dynes/cm, so for a multicomponent fiber comprising a polyolefin component and a polyester (or nylon) component the difference in component surface energies would be at most about 15 dynes/cm. However, the surface energy of filler materials is much higher than that of the polymers, typically higher by about an order of magnitude. For example, some exemplary filler materials are titanium dioxide and calcium carbonate, both having surface energies over 300 dynes/cm, or about ten times that of the polymers described.

Therefore, we believe adding to one component polymer substantial amounts of filler material having a surface energy substantially higher than that of the other component polymer, such as in amounts greater than about 10 percent by weight of the component, acts to increase the average surface energy of the filled component such that the difference in surface energies between the filled component and the non-filled component is now much larger than is the case for the unfilled polymer components. This difference in surface energy results in a weld-line or interface between the adjacent polymer components which is weaker in terms of component-to-component adhesion than would be the case for the two components without modification of the surface energy of one of the components. A weld-line or interface with weaker component-to-component adhesion allows the components of the fiber to be split apart more easily. It should be noted that although we have described the splittable multicomponent fibers in terms of filled and non-filled adjacent components, it may be possible to add filler material to more than one, or all, adjacent components where, due to either type or amount of filler material used, there still exists a substantial difference in surface energy between the adjacent components.

The present multicomponent fibers, fine denier split fibers, and fabrics produced from the multicomponent fibers and/or fine denier split fibers can be characterized in that the fibers can be split or fibrillated by applying to the fibers and fabrics a minimum of mechanical energy or force in a wide range of forms without the need for chemicals added to the components of the multicomponent fibers, and without the need for chemicals applied to dissolve out components of the multicomponent fibers. Surprisingly, it has been found that while incompatible or immiscible polymers may be used as the components of the multicomponent fibers, the present multicomponent splittable fibers may also be formed and split even when the polymers used in the components of the fiber are not incompatible. Further, the multicomponent fibers of the present invention may even be formed of components comprising the same polymer, so long as at least one of the components is a filled polymer, that is, as long as at least one of the components further comprises at least about 10 percent by weight of filler material. For example, the splittable multicomponent fibers and fine denier split fibers may be formed from a polypropylene-polypropylene multicomponent fiber wherein one component is polypropylene loaded with at least about 10 percent by weight filler, and the second component consists essentially of polypropylene (i.e., may have small amounts of colorants and/or processing additives up to about 5 percent by weight, but is not loaded with at least about 10 percent by weight filler).

FIG. 9 illustrates an exemplary process for producing the splittable multicomponent filaments and fine denier split fiber webs of the present invention. A process line 10 is arranged to produce a spunbond nonwoven web of splittable multicomponent fibers containing two polymer components, however it should be understood that the present invention encompasses splittable multicomponent filaments and fine denier split fibers, and fabrics therefrom, which are made with more than two components. The process line 10 includes a pair of extruders 12a and 12b for separately extruding polymer component A and polymer component B. Polymer component A is fed into the respective extruder 12a from a first hopper 13a and polymer component B is fed into the respective extruder 12b from a second hopper 13b.

The polymers selected for the components of the multicomponent fiber may be incompatible or compatible polymers, or may indeed be the same polymer. However, one of the component polymers will have added to it, for example, into its respective feed hopper and extruder an effective amount of filler material in accordance with the present invention. The filler material may be added to the feed hopper of the extruder as a concentrate which has been compounded with the component polymer. As an example, a 50 percent by weight compound of filler material and polymer added to the feed hopper of one extruder at a rate of 20 kilograms of filler-polymer compound to 80 kilograms of polymer component will result in a splittable multicomponent filament wherein at least one component polymer further comprises 10 percent by weight of the component of filler material. Alternatively, the filler material may be injected into the extruder by other means known to the art as for example by use of a cavity transfer mixer (not shown), or the filler may be coated onto pellets of the virgin polymer component. As mentioned above, other effective amounts of filler loading may be employed.

Polymer components A and B are fed from the extruders 12a and 12b to a spinneret 14. Spinnerets for extruding multicomponent filaments are well known to those of ordinary skill in the art and thus are not described here in detail. Generally described, the spinneret 14 includes a housing containing a spin pack which includes a plurality of plates stacked one on top of the other with a pattern of openings arranged to create flow paths for directing polymer components A and B separately through the spinneret. An exemplary spin pack for producing multicomponent filaments is described in U.S. Pat. No. 5,989,004 to Cook, the entire contents of which are herein incorporated by reference.

The spinneret 14 has openings or spinning holes called capillaries arranged in one or more rows. Each of the spinning holes receives predetermined amounts of the component extrudates in a predetermined sectional configuration, forming a downwardly extending strand of the splittable multicomponent filament. The spinneret produces a curtain of the splittable multicomponent filaments. A quench air blower 16 is located adjacent the curtain of fibers extending from the spinneret 14 to quench the polymer compositions of the filaments. The quench air can be directed from one side of the filament curtain as shown in FIG. 9, or both sides of the filament curtain. As used herein, the term “quench” simply means reducing the temperature of the filaments using a medium that is cooler than the filaments such as using, for example, ambient air.

The filaments are then fed through a pneumatic filament draw unit or aspirator 18 which provides the drawing force to attenuate the filaments, that is, reduce their diameter, and to impart molecular orientation therein and, thus, to increase the strength properties of the filaments. Pneumatic fiber draw units are known in the art, and an exemplary fiber draw unit suitable for the spunbond process is described in U.S. Pat. No. 3,802,817 to Matsuki et al., herein incorporated by reference. Generally described, the fiber draw unit 18 includes an elongate vertical passage through which the filaments are drawn by drawing aspirating air entering from the sides of and flowing downwardly through the passage. The aspirating air may be heated or unheated. During the fiber drawing process, the fibers can be simultaneously crimped and drawn when the components are arranged in a crimpable asymmetric configuration by the use of heated aspirating air which both attenuates the filaments and activates latent helical crimp. This simultaneous drawing and crimping process is more fully disclosed in above-mentioned U.S. Pat. No. 5,382,400 to Pike et al. Alternatively, when it is desired to activate the latent helical crimp in the filaments at some point following filament laydown, unheated aspirating air is supplied to filament draw unit 18. In this instance, heat to activate the latent crimp would be supplied to the fabric at some point after filament laydown. As yet another alternative, where little or no fiber crimp is desired the filament draw unit 18 is supplied with unheated air and a non-crimping component arrangement in the splittable multicomponent filament is used.

An endless foraminous forming surface 20 is positioned below the filament draw unit 18 to receive the drawn filaments from the outlet opening of the filament draw unit 18 as a formed web 22 of splittable multicomponent filaments. Alternatively, the drawn filaments exiting the filament drawing unit 18 can be collected for further processing into splittable fibers or yarns. As another alternative, the drawn filaments exiting the filament draw unit 18 may be contacted with a scraping blade or other means attached at the bottom of the draw unit 18 (not shown) to impart mechanical force to the splittable multicomponent filaments, thereby splitting some or all of the filaments into fine denier split fibers before their formation into a web.

A vacuum apparatus 24 is positioned below the forming surface 20 to facilitate the proper placement of the filaments. The formed web 22 is then carried on the foraminous surface 20 to calender bonding rollers 34, 36. Although calender bonding is shown in FIG. 8, any nonwoven fabric bonding process can be used to bond the formed web, including calender bonding as mentioned, pattern bonding, flat calender bonding, ultrasonic bonding, through-air bonding, adhesive bonding, and hydroentangling or mechanical needling processes. As mentioned, a pattern bonding process is shown which employs pattern bonding roll pairs 34 and 36 for effecting bond points at limited areas of the web by passing the web through the nip formed by the bonding rolls 34 and 36. One or both of the roll pair have a pattern of land areas and depressions on the surface, which effects the bond points, and either or both may be heated to an appropriate temperature. The temperature of the bonding rolls and the nip pressure are selected so as to effect bonded regions without having undesirable accompanying side effects such as excessive shrinkage, excessive fabric stiffness and web degradation. Although appropriate roll temperatures and nip pressures are generally influenced by parameters such as web speed, web basis weight, fiber characteristics, component polymers and the like, the roll temperature desirably is in the range between the softening point and the crystalline melting point of the lowest melting component polymer which is used in the multicomponent fiber. For example, desirable settings for bonding a fiber web that contains splittable or split polypropylene fibers are a roll temperature in the range of about 125° C. and about 160° C. and a pin pressure on the fabric in the range of about 350 kg/cm2 and about 3,500 kg/cm2.

Other exemplary bonding processes suitable for the present fine fiber fabric include through-air bonding processes. A typical through-air bonding process applies a flow of heated air onto the web to effect inter-fiber bonds, and the bonding process is particularly useful for nonwoven webs containing at least one high melting component and one low melting component such that the low melting component can be heat activated to form inter-fiber bonds while the high melting component retains the physical integrity of the webs. The heated air is applied to heat the web to a temperature above the melting point of the lowest melting polymer of the web but below the melting point of the highest melting polymer of the web. A through-air bonding process does not require any significant compacting pressure and, thus, is highly suitable for producing a lofty bonded fabric.

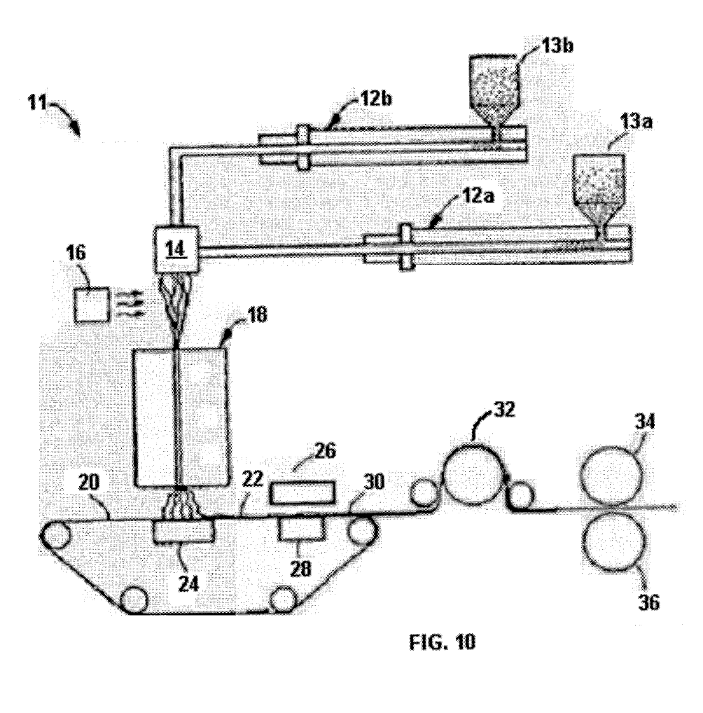

For splitting of the splittable multicomponent filaments of the formed web, the web may be passed through a splitting station either before or after web bonding. FIG. 10 illustrates an exemplary process 11 for splitting the multicomponent filaments prior to web bonding. The splittable multicomponent filaments are formed into web 22 of splittable filaments as in FIG. 9. However, in FIG. 10 a splitting treatment station 26 is used to impart mechanical energy to web 22, thereby splitting the multicomponent filaments and forming fine denier split fiber web 30. Splitting treatment station 26 may be, for example, a hydroentangling station, also known in the art as a hydro-needling station. Alternatively, splitting treatment station 26 may be a mechanical needling station. Where hydroentangling or mechanical needling is used to split the splittable multicomponent filaments, the splitting treatment will also impart substantial bonding to the web due to filament entanglement. However, where desired, additional bonding may still be supplied to the fine denier split fiber web 30 in the form of calender bonding, through-air bonding, ultrasonic bonding, et cetera. Where splitting treatment station 26 is a hydroentangling station, vacuum 28 may be employed to hold web 22 to the foraminous surface 20 and to act as a receptacle for the water which has passed through web 22 and foraminous surface 20. Again referring to FIG. 10, where splitting treatment station 26 is a hydroentangling station, drying station 32 may be advantageously used to remove residual water which remaining on fine denier split fiber web 30 from the splitting process. Drying station 32 may be drying cans as are known in the art, a through-air dryer, or a through-air dryer-bonder combination. Additional web bonding may be performed at calender rolls 34 and 36.

Other means for splitting the multicomponent filaments may be employed and other process variables are within the scope of the invention. For example, the splitting treatment station depicted in FIG. 10 may be positioned over a secondary conveyor belt to which the formed web 22 has been transferred, rather than being positioned over the foraminous forming surface 20 as in FIG. 10. As another example, the splitting treatment station may be a doctor blade or other hard, sharp surface against which the multicomponent filaments are scraped in order to effect splitting. As still further examples, the splitting treatment may consist of treating either the multicomponent filaments themselves or yarns or fabrics formed therefrom to crush-rolling under pressure in a nip between steel or other hard-surfaced rollers, brushing with brush rollers, or stretching or secondary drawing as between two or more pairs of nipped rollers where the second pair of nipped rollers rotates at a speed greater than that of the first pair of rollers. Additionally, a formed fabric may also be stretched by such treatments as intermeshing rollers or tenter-frame stretching, and fibers may be subjected to such treatments as flexing or twisting.

While not shown here, various additional potential processing and/or finishing steps known in the art such as aperturing, slitting, stretching, treating, or further lamination with other films or other nonwoven layers, may be performed without departing from the spirit and scope of the invention. Examples of web finishing treatments include electret treatment to induce a permanent electrostatic charge in the web, or antistatic treatments. Another example of web treatment includes treatment to impart wettability or hydrophilicity to a web comprising hydrophobic thermoplastic material. Wettability treatment additives may be incorporated into the polymer melt as an internal treatment, or may be added topically at some point following filament or web formation.

The splittable multicomponent filament fabric and split fine denier fabric of the present invention provide for a combination of desirable properties of conventional microfiber fabrics and highly oriented fiber fabrics. The split fiber fabric exhibits desirable properties, such as uniformity of the fabric, uniform fiber coverage, barrier properties and high fiber surface area which are similar to microfiber fabrics. In addition, and unlike microfiber fabrics such as meltblown webs, the fine denier split fiber fabric also exhibits highly desirable strength properties, desirable hand and softness and can be produced to have different levels of loft. The desirable strength properties are attributable to the high level of molecular orientation of the precursor multicomponent fibers, unlike meltblown microfibers. The desirable textural properties are attributable to the fineness of the split fibers, unlike oriented conventional unsplit fibers.

Fabrics containing the fine denier split fibers of the invention are highly suitable for various uses. For example, nonwoven fabrics containing the fine denier split fibers are highly suitable for various uses including disposable articles, e.g., protective garments, sterilization wraps, wiper cloth and covers for absorbent articles; and woven and knitted fabrics containing the fine denier split fibers that exhibit highly improved softness and uniformity are highly useful for soft apparel, dusting and wiper cloth and the like.

As another embodiment of the present invention, the soft, strong fine fiber fabric may be used as a laminate that contains at least one layer of the fine denier split fiber fabric and at least one additional layer of another woven or nonwoven fabric, or a film, or foam. The additional layer for the laminate is selected to impart additional and/or complementary properties, such as liquid and/or microbe barrier properties. The layers of the laminate can be bonded to form a unitary structure by a bonding process known in the art to be suitable for laminate structures, such as thermal, ultrasonic or adhesive bonding processes.

A laminate structure highly suitable for the present invention is disclosed in U.S. Pat. No. 4,041,203 to Brock et al., which is herein incorporated in its entirety by reference. In adapting the disclosure of U.S. Pat. No. 4,041,203, a pattern bonded laminate of at least one split or splittable continuous multicomponent filament nonwoven web, e.g., a split spunbond multicomponent fiber web, and at least one microfiber nonwoven web, e.g., meltblown web, can be produced. Such a laminate combines the strength and softness of the fine denier split fiber fabric and the breathable barrier properties of the microfiber web. Alternatively, a breathable film can be laminated to the fine denier split fiber web to provide a breathable barrier laminate that exhibits a desirable combination of useful properties, such as soft texture, strength and barrier properties. As yet another embodiment of the present invention, the fine fiber fabric can be laminated to a non-breathable film to provide a strong, high barrier laminate having a cloth-like texture. These laminate structures provide desirable cloth-like textural properties, improved strength properties and high barrier properties. The laminate structures, consequently, are highly suitable for various uses including various skin-contacting applications, such as protective garments, covers for diapers, adult care products, training pants and sanitary napkins, various drapes, and the like.

The following example is provided for illustration purposes and the invention is not limited thereto.

### EXAMPLE

Multicomponent fibers were produced having filled and unfilled components wherein the filled component was polypropylene filled with 10 percent by weight of talc and the unfilled component was polypropylene. The multicomponent fibers were formed using a circular spinneret or spinning plate having 20 capillaries and using a 4-part segmented pie or wedge distribution scheme such as is demonstrated schematically in FIG. 2A, wherein the fiber components alternated as filled and unfilled wedges. The multicomponent fibers were exposed to secondary drawing by hand (that is, the fibers were stretched or drawn by hand at a time after they had been allowed to cool and solidify), whereupon the fibers split into component parts.

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

We claim:

1. A splittable multicomponent fiber comprising at least two thermoplastic polymer components arranged in distinct zones across the cross-section of the fiber extending substantially continuously along the length of the fiber, at least one of said thermoplastic polymer components comprising about 10 percent by weight to about 95 percent by weight of filler material.

2. The splittable multicomponent fiber of claim 1 wherein said filler material is selected from the group consisting of talc, calcium carbonate and titanium dioxide.

3. The splittable multicomponent fiber of claim 1 wherein said at least one of said thermoplastic polymer components comprises about 10 percent by weight to about 70 percent by weight of filler material.

4. The splittable multicomponent fiber of claim 3 wherein said at least one of said thermoplastic polymer components comprises about 10 percent by weight to about 50 percent by weight of filler material.

5. The splittable multicomponent fiber of claim 4 wherein said at least one of said thermoplastic polymer components comprises about 10 percent by weight to about 30 percent by weight of filler material.

6. The splittable multicomponent fiber of claim 1 wherein said at least one of said thermoplastic polymer components comprises at least about 20 percent by weight of filler material.

7. The splittable multicomponent fiber of claim 1 wherein at least two of said at least two thermoplastic polymer components comprise polyolefin.

8. The splittable multicomponent fiber of claim 7 wherein said thermoplastic polymer components comprise the same polymer.

9. The splittable multicomponent fiber of claim 8 wherein said thermoplastic polymer components comprise polypropylene.

10. The splittable multicomponent fiber of claim 1 wherein said fiber is substantially continuous.

11. The splittable multicomponent fiber of claim 7 wherein said fiber is substantially continuous.

12. A split fiber formed from the splittable multicomponent fiber of claim 1.

13. A fabric comprising the split fiber of claim 12.

14. A nonwoven fabric comprising the split fiber of claim 12.

15. A personal care absorbent product comprising the nonwoven fabric of claim 14.

16. A personal care absorbent product comprising the split fiber of claim 12.

17. A fabric comprising at least first and second split fiber groups, said first split fiber group comprising a first polymeric thermoplastic component and said second split fiber group comprising a second thermoplastic polymeric component, wherein said second thermoplastic polymeric component comprises about 10 percent by weight to about 95 percent by weight of filler material.

18. The fabric of claim 17 wherein said filler material is selected from the group consisting of talc, calcium carbonate and titanium dioxide

19. The fabric of claim 17 wherein said second thermoplastic polymeric component comprises about 10 percent by weight to about 70 percent by weight of filler material.

20. The fabric of claim 19 wherein said second thermoplastic polymeric component comprises about 10 percent by weight to about 50 percent by weight of filler material.

21. The fabric of claim 20 wherein said second thermoplastic polymeric component comprises about 10 percent by weight to about 30 percent by weight of filler material.

22. The fabric of claim 17 wherein said fabric is a nonwoven fabric.

23. A personal care absorbent product comprising the nonwoven fabric of claim 22.

24. The fabric of claim 22 wherein said first and second thermoplastic polymeric components comprise polyolefin.

25. The fabric of claim 24 wherein said first and second thermoplastic polymeric components comprise the same polyolefin polymer.

26. The fabric of claim 25 wherein said first and second thermoplastic polymeric components comprise polypropylene.

27. A process for making split fibers comprising the steps of:
a) providing precursor multicomponent fibers comprising at least two thermoplastic polymer components arranged in distinct zones across the cross-section of the fiber extending substantially continuously along the length of the fiber, at least one of said thermoplastic polymer components comprising about 10 percent by weight to about 95 percent by weight of filler material; and
b) subjecting the precursor multicomponent fibers to splitting treatment to split the precursor multicomponent fibers into separate components.

28. The process of claim 27 wherein said splitting treatment is selected from the group consisting of secondary drawing, crush rolling, scraping, flexing and twisting.

29. A process for making a split fiber fabric comprising the steps of:
a) providing precursor multicomponent fibers comprising at least two thermoplastic polymer components arranged in distinct zones across the cross-section of the fiber extending substantially continuously along the length of the fiber, at least one of said thermoplastic polymer components comprising about 10 percent by weight to about 95 percent by weight of filler material;
b) forming the precursor multicomponent fibers into a fabric; and
c) subjecting the fabric to splitting treatment split the precursor multicomponent fibers into separate components.

30. The process of claim 29 wherein said splitting treatment is selected from the group consisting of stretching, crush rolling, scraping, hydraulic needling, mechanical needling and brushing.
